(19) United States
(12) Patent Application Publication
(10) Pub. No.: US 2023/0329943 A1
(43) Pub. Date: Oct. 19, 2023

(54) PROTECTIVE HOOD

(71) Applicant: Mercedes-Benz Grand Prix Limited, Northamptonshire (GB)

(72) Inventor: Christian Fletcher, Northamptonshire (GB)

(73) Assignee: Mercedes-Benz Grand Prix Limited, Northamptonshire (GB)

(21) Appl. No.: 18/005,042

(22) PCT Filed: Jul. 8, 2021
(86) PCT No.: PCT/GB2021/051740

§ 371 Date: Jan. 10, 2023

(30) Foreign Application Priority Data
Jul. 10, 2020 (GB) 2010682.9

(51) Int. Cl. A61G 10/00; A61G 10/02

(52) U.S. Cl. CPC A61G 10/005; A61G 10/023

(57) ABSTRACT

The present invention relates to a covering 10 for a body part of a patient. The covering 10 comprising a plurality of transparent semi rigid sheet segments 14, a fastener 20 for connecting the plurality of sheet segments 14 together such that the sheet segments 14 support each other to form a self-supporting structure 12. The self-supporting structure 12 being suitable for covering the body part of a patient, thereby protecting medical professionals from harmful fluids or aerosols emanating from the patient.

### FIELD

The present disclosure relates to the field of medical items used to protect a medical professional from fluids. More specifically the subject matter of the present disclosure relates to coverings suitable for covering a part of a patient's anatomy for protecting medical professionals from harmful fluids or aerosols emanating from the patient's anatomy.

### BACKGROUND

Some medical procedures carry a risk of medical practitioners being exposed to pathogens emanating from a patient's body or of noxious gases that may be generated during the medical procedures, for example when using cauterising devices. It is desirable to provide a barrier between the site of a patient's body from which such gases emanate and the medical practitioner.

Coverings for covering a part of a patient's anatomy for this purpose are known. However, some such coverings are both heavy and consequently cumbersome to handle, at least for a single medical practitioner, or are too flexible to provide a reliable barrier.

### SUMMARY

According to an embodiment there may be provided a covering for a body part of a patient, comprising a plurality of transparent semi rigid sheet segments, fasteners for connecting the plurality of sheet segments together such that the sheet segments may support each other to form a self-supporting structure suitable for covering the body part of a patient.

In an embodiment, a sheet of the plurality of sheets is a curved sheet that has a curvature in a first direction. A connection between the curved sheet and another sheet of the plurality of sheets forms an edge. In an embodiment, the curved sheet may be considered to curve about an axis that is parallel to the curved sheet along a second direction in which the curved sheet remains straight/is not curved. In one embodiment, the other sheet is planar and is arranged so that the sheet is not in a plane that comprises the axis. In another embodiment, the other sheet is another curved sheet that also curves about a direction and that also defines an axis that is parallel to the other curved sheet along a second direction of the other curved sheet in which the other curved sheet remains straight/is not curved. The axes of the curved sheet and of the other curved sheet are non-parallel.

The plurality of sheet segments may comprise a plurality of openings for the insertion of arms into an inside of the covering, wherein the rigidity of the structure is sufficient for the dome structure to, when an arm is inserted into the chamber through an opening, resists movement thereby minimising or preventing expulsion of a gas within the covering to an outside.

In an embodiment, the plurality of transparent semi-rigid sheets may be made of a polymeric material.

The transparent semi-rigid sheet segments may comprise a material having a Flexural modulus of between 400 MPa and 7500 MPa. The transparent semi-rigid sheet segments may have a thickness of between 0.2 mm and 3.0 mm. The opening hay have a widest dimension of between 150 mm and 250 mm.

In an embodiment, the fastening means may be releasable. In an embodiment, the fastening means may comprise a zipper and/or a hook and loop type fastening.

The total open area of each opening in a first state may be 10 cm², wherein in the first state no arm is inserted into the chamber and wherein the total open area is the area that provides fluid communication between the inside and outside of the chamber.

The total open area of an opening in a second state may be a maximum of 25 cm², wherein in the second state all openings have arms inserted into the chamber and wherein the total open area is the area that provides fluid communication between the inside and outside of the chamber.

At least one of the openings is covered by a flexible seal, the flexible seal may comprise an elastically deformable seal opening configured to admit a human arm through the seal opening.

In an embodiment, the flexible seal is configured to elastically assume a relaxed position when nothing is inserted through the seal opening, wherein in the relaxed position a fluid flow cross section through the seal opening is minimised or substantially eliminated. The flexible seal and the seal opening may be configured to deform around an inserted arm to create a maximum total opening area around the arm through the seal opening for fluid communication between the inside and the outside of the chamber of less than or equal to 25 cm².

In one embodiment, the covering comprises a releasable attachment means for releasably attaching the covering to a bed. At least one of the transparent semi-rigid sheets may comprise a bougie opening positioned near an apex of the cover.

At least one of the transparent sheet segments may further comprise a reinforcing means for increasing the stiffness of the dome in a direction orthogonal to the axis.

In one embodiment, the covering is reusable. The transparent semi-rigid sheet segments, when not fastened to each other, may be rollable into a tubular shape. When assuming the tubular shape the rolled sheets can easily be submerged in a decontamination bath.

In an embodiment, the covering is suitable for positioning on any hospital bed size or design including at an inclinable bed at an inclination of between 0° and 75° .

At least one of the transparent sheet segments may comprise an arched edge for permitting a patient's body part to extend between an inside and an outside of the covering.

The arched edge may be such that, when the covering is placed over a part of a patient's anatomy the arched edge is sized and/or shaped so that other parts of the patient's anatomy can protrude from under the covering without pressure being exerted on the other parts of the patient's anatomy. The other part of the patient's anatomy may be an arm or a leg of the patient, the patient's torso or abdomen or the patient's neck. It will be appreciated that the other part of the patient's anatomy is dependent upon the part of the patient's anatomy covered by the covering. It will moreover be appreciated that a covering may have more than one sheet with an arched opening of this nature. A cover designed to covering the head of a patient, for example, may have two arched edges in opposing side panels of the cover to allow a patient's arms to protrude from the opening and an additional opening or edge in a panel between the two side panels, allowing a patient's torso to protrude from under the cover. It will be understood that the terms “cover” and “covering” are used interchangeably herein. In a preferred embodiment, two adjacent arched openings are not contiguous and instead are separated by a part of the covering that, when the covering is placed over a patient, is configured to contact a surface upon which the patient rests. In this manner the danger of the cover's weight or of forces exerted on the covering when performing a procedure on the patient being applied to the anatomy of the patient is avoided or at least mitigated.

According to an embodiment there is provided a covering for a body part of a patient, comprising a structure for covering a patient's body part comprising a plurality of semi-rigid sheet segments and connected to each other along joins and forming a chamber between the structure and a surface upon which the structure rests and/or the patient. The covering may comprise a plurality of openings for insertion of arms into the chamber, wherein a part of the covering comprising said plurality of openings curves convexly outwardly so as to provide an unobstructed view into the chamber.

It will be appreciated that the covering may comprise the features of any of the hereinbefore-described coverings. In an embodiment, the dome has a substantially square base defining four sides, one or more or all of which curve towards an apex. In one embodiment, at least one opening is provided on each side.

The plurality of transparent sheet segments may comprise complimentary shapes configured to provide the self-supporting dome shape, with seams connecting the sheets positioned such that they are out of the line of sight of a human of average height manipulating a patient positioned horizontally at a height between 60 and 100 cm above ground.

More preferably, the seams connecting the sheet segments are positioned such that they are out of the line of sight of a human of average height manipulating a patient positioned horizontally at a height between 45 and 135 cm above ground.

For the purposes of this disclosure the average height of a human male is 171 cm and of a human female 159 cm. ICU beds can be height adjustable within a range of 31 to 92 cm above ground. The patient rests on a mattress that is approximately 14-23 cm thick. Operating tables have a height of between 58 and 132 cm above ground. The patient lies on a mattress that is between 5 and 12 cm thick. The transparent sheet segments of the covering curve such that any joints between adjacent transparent sheets are, for this range of resting height of the patient above ground and for these average human body heights, are not located within a line of sight of a human having his or her arms inserted into the covering through arm openings and looking to a centre of the inside of the covering.

According to an embodiment there is provided a covering for a body part of a patient, comprising a substantially dome shaped structure for covering a patient's body part and forming a chamber between the dome and a surface and/or patient. The structure comprising edges that may, in use, be placed adjacent part of a patient's anatomy or a surface upon which a patient rests; wherein at least one of the edges comprises a pliable skirt for providing continuous contact between the base of the dome and a surface and/or a body part of a patient.

In an embodiment, the pliability of the skirt is such that it is not able to support its own weight in a manner that forms fluid flow channels between the skirt material and a surface upon which the skirt material rests.

It will be appreciated that the covering may comprise the features of any of the hereinbefore-described coverings.

The skirt may comprise accessible portions that are openable and closable to allow insertion of items into the chamber. The accessible portions may comprise double zips.

According to an embodiment there is provided a covering for a body part of a patient, comprising a substantially dome shaped structure for covering a patient's body part and forming a chamber between the dome and a surface and/or patient. The covering may comprise a plurality of overlapping components, wherein overlapping components are connected using a spacer or spacers that allow for ingress of liquid between the sheets.

It will be appreciated that the covering may comprise the features of any of the hereinbefore-described coverings.

The covering may further comprise a pliable skirt arranged along at least one edge of the covering, the skirt overlapping a sheet material forming the edge and connected to the sheet material using a spacer or spacers that allow ingress of liquid between the sheet material.

The spacer or spacers may comprise a woven fluid permeable material. According to an embodiment there is provided a set of semi-rigid sheets and fasteners, assemblable into a covering according to any preceding covering by connecting the sheets using the fasteners.

According to an embodiment there is provide a safety apparatus comprising a substantially dome shaped covering for covering a patient's body part suitable for forming a chamber between the dome and a surface and/or patient. The covering may comprise a plurality of openings for insertion of arms into the chamber and an extraction means connectable to the chamber and suitable for continuously extracting gas from the chamber at a rate that creates an inflow of gas through the openings towards the extraction means, thereby preventing gas escaping from the chamber through the openings.

The extraction means may be in fluid communication with the chamber at two positions. The extraction means may comprise a tube having a first end and a second end, wherein the tube is in fluid communication with the chamber at the first end and connected to a pump at the second end. The extraction means may further comprise a gas filter positioned between the chamber and the pump, for filtering the gas extracted from the chamber. The extraction means may be configured to extract gas from the chamber at a rate of at least 400 L/min.

### BRIEF DESCRIPTION OF THE DRAWINGS

Embodiments of the invention will now be described by way of example with reference to the accompanying drawings in which:

FIG. 1 shows an embodiment of a covering being placed over a patient with two medical practitioners performing intubation on the patient;

FIG. 2 shows an embodiment of the covering in disassembled form;

FIG. 3 shows an embodiment of the covering in assembled form;

FIG. 4 (a) shows use of a covering of an embodiment on a patient in the supine position with an elevated upper body;

FIG. 4 (b) shows use of a covering of an embodiment on a patient in the supine position;

FIG. 4 (c) shows use of a covering of an embodiment on a patient in the prone position;

FIG. 5 shows a sealed arm opening in a covering of an embodiment;

FIGS. 6 (a) and (b) show an opening without and with an arm inserted, respectively;

FIG. 7 shows a tool port provided at an apex of a covering of an embodiment;

FIG. 8 shows detail of a pliable skirt and access zips provided along lower edges of a covering of an embodiment;

FIG. 9 shows a method of decontamination of a disassembled covering of an embodiment;

FIG. 10 shows an example of a mesh container for use in decontamination of a covering of an embodiment;

FIG. 11 shows the architecture of the join between overlapping components of a covering of an embodiment;

FIGS. 12 (a)-(h) show embodiments of a covering according an embodiment;

FIG. 13 shows use of an extraction system to extract air from a covering of an embodiment;

FIG. 14 shows an embodiment of a covering with an extraction system connected to it;

FIG. 15 shows a gas extraction access port in a covering of an embodiment;

FIG. 16 shows a virtual representation of a covering of an embodiment placed on a patient for the purpose of numerical airflow simulation; and

FIG. 17 shows results of the airflow simulation on a model illustrated in FIG. 16;

### DETAILED DESCRIPTION

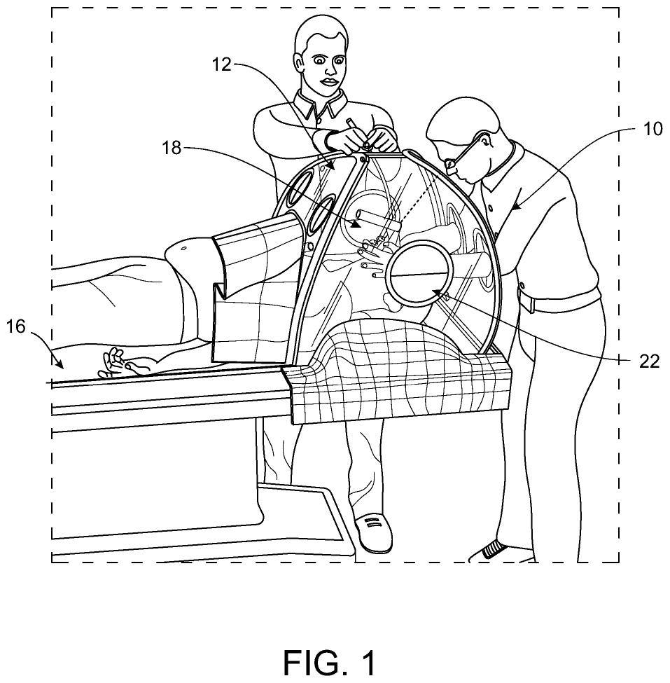

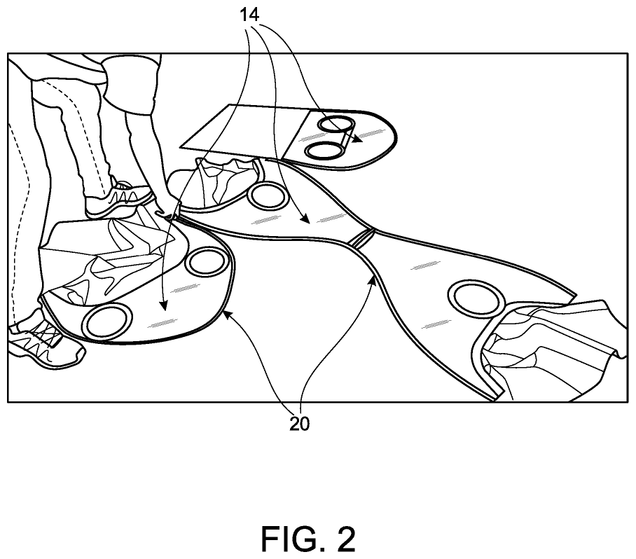

FIG. 1 depicts an example of a covering 10 according to an embodiment. The cover 10 is substantially transparent such that it covers a patient's body part but the body part remains visible. The cover 10 comprises a dome 12 formed by a plurality of transparent sheet segments 14 shown in FIG. 2. The plurality of transparent sheet segments 14 can comprise a single sheet comprising a specific shape or multiple separate sheets. It will be understood that the term transparent sheet segments and transparent sheets are used interchangeably herein. Transparent sheets are sheets that comprise at least a portion through which objects can be distinctly seen. The transparent sheets 14 are semi-rigid so that they can be curved and interlocked to form the dome shape 12. The lower edges of the covering 10/ dome 12 are suitable for placing on a surface, for example a mattress 16, whereby the dome remains self-supporting and upright on the surface. As shown in FIG. 1, the covering 10 is positioned at the upper part of a mattress 16, in this example covering a patients head and shoulders. The covering creates a chamber 18 between the dome 12 and the surface (mattress 16 ) and/or the patient. It will be appreciated that the covering 10 could be positioned on a different part of the mattress 16 and/or to cover a different part of a patient's body.

The dome 12 provides a barrier between a person outside the covering 10 and the chamber 18 and, in doing so, blocks aerosols emanating from the patient/patient's body part from reaching the person outside. The chamber 18 encloses the patient's body part, in this example the patient's head and shoulders. Therefore, the dome 12 blocks fluids within the chamber reaching a person outside the covering regardless of where they are standing around the covering 10.

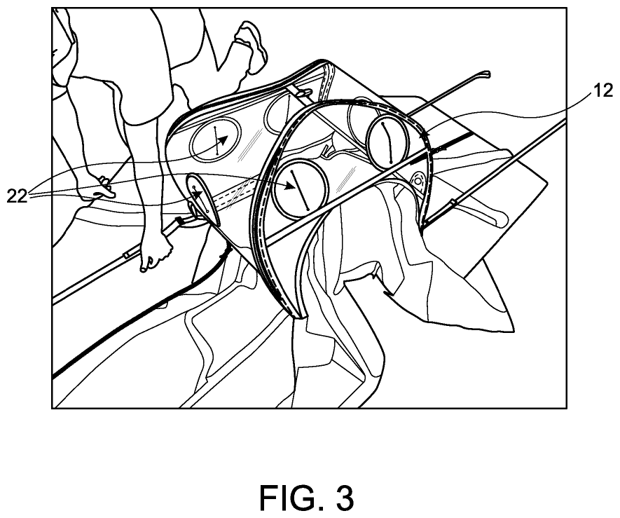

As discussed above the dome 12 is self-supporting. This is achieved due to the semi-rigidity nature of the transparent sheets 14. As shown in FIG. 2, three transparent sheets 14 form the covering 10. The three transparent sheets 14 are provided flat as shown in FIG. 2 and can be assembled in situ. FIG. 3 shows the sheets 14 fastened together to form dome 12. Assembly is possible without the use of tools due to the use of a releasable fastener like the zip 20 shown in FIG. 2. Although a zip is described, it will be understood than any suitable fastening means is encompassed by the present disclosure. These may include any fastening system that enables tool free and familiar assembly. This may be discrete system of multiple hook and loop features cut into the panels or series of press-studs. Additionally or alternatively continuous fasteners, such as zips or tongue and groove channels are used. The use of widely known fasteners allows assembly and disassembly of the dome 12 to be carried out quickly and without special training. The structure of the dome 12 allows the transparent sheets 14 to support each other, forming a self-supporting freestanding dome 12. The dome 12 shown does not require additional structural members to enable it to maintain its shape, although such members can be added, if desired. An example of such additional structural members can be seen in FIG. 3, where one structural member extends just above or below the arm openings in each of the semi-rigid panels. The additional structural member may be a fibreglass rod or a similarly rigid elongate member. Preferably any additional structural member extends across a widest portion of a semi-rigid sheet 14 in a direction that is orthogonal to the direction of curvature of the sheet 14.

It will be appreciated that while the dome 12 shown in FIG. 2 comprises three transparent sheets 14, in different embodiments the dome 12 may be formed using a different number of transparent sheets, such as one, two or four transparent sheets.

Whilst the semi-rigid sheets 14 can easily be curved to adopt the shapes shown in FIGS. 1 and 3 respectively, once the semi-rigid sheets 14 are curved, the curved semi-rigid sheet 14 provides resistance against deformation in a direction orthogonal to the direction of its curvature. The perpendicular skin stiffness is capable of supporting 10 N point load force and offer between 0.3 and 1.5 N/mm stiffness within this load range. The semi-rigid sheets 14 may, for example, be considered, in the configuration shown in FIGS. 1 and 3, to be curved about a horizontally extending axis that is parallel to the direction of the sheet in which the sheet has not been curved. As adjacent semi-rigid sheets 14 of the cover 10 are connected to the curved sheet and at a non-zero angle, the resistance against deformation the curved sheet provides in the direction orthogonal to its direction of curvature/along the parallel axis, the mutual support provided by connected sheets renders the assembled structure resistant to deformation to a degree that exceeds the deformation resistance of individual sheets in a flat state. As adjacent sheets are connected to each other continuously or at numerous points along an edge of the cover 10, the sheets further support each other in retaining their curvature.

It is noted that for the purposes of the present disclosure the described curvature does not have to the cylindrical in nature and instead encompasses any curvature that fulfils the purpose of preventing connections between adjacent sheets from obstructing the line a few of medical practitioners.

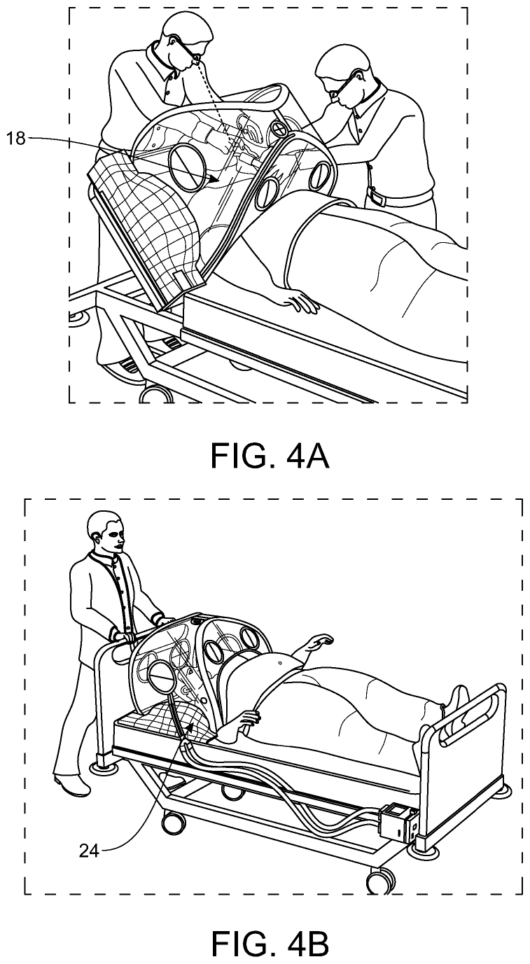

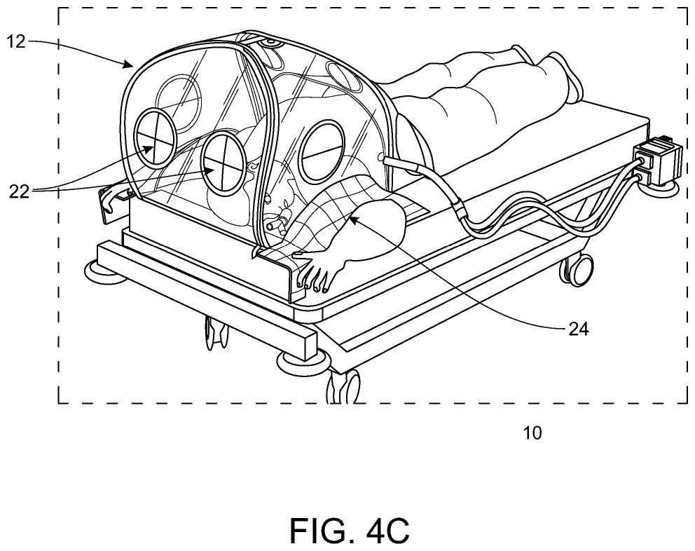

The transparent nature of the sheets 14 in combination with the position of the fastening provides maximum visibility through the covering 10 to the chamber 18 to a person outside the covering 10. The sheets 14 are formed from a material which exhibits light transmission property of greater than 85% and light refractive index of less than 1.7. The walls of the dome 12 are convex towards the outside, so that they curve toward an apex of the dome 12. In the embodiment shown in FIG. 1, the curved sheet at the top end of the cover 10 and the two curved sheets forming side walls protrude outwardly most at a height at which access openings for a medical practitioner's arms are provided. This curvature has the effect that the joints between adjacent panels are located away from a line of sight of a medical practitioner performing a procedure on the patient under the dome 12 so that they do not obstruct the medical practitioner's view, as shown by the broken line in FIG. 1 and FIG. 4 (a). It will be understood that, although these FIGS. illustrate the unobstructed nature of the practitioner's view using an example of a practitioner manipulating a patient from a head-end of the dome 12, the view afforded a practitioner accessing the dome 12 from a side is equally unobstructed given the curving nature of the side panels of the dome 12.

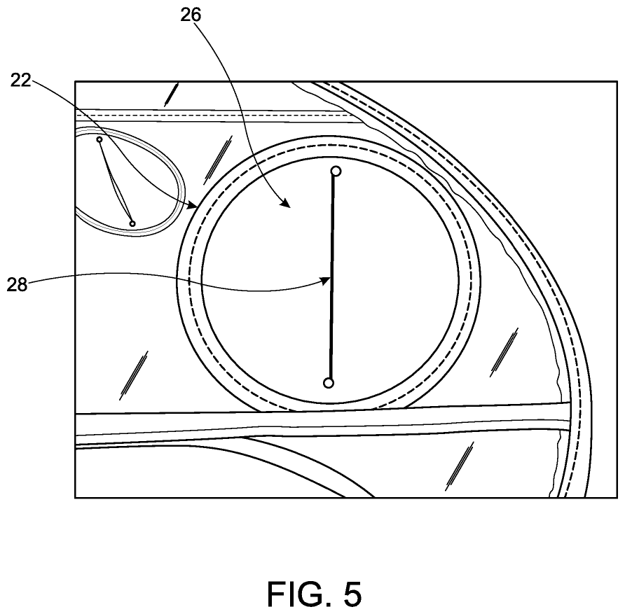

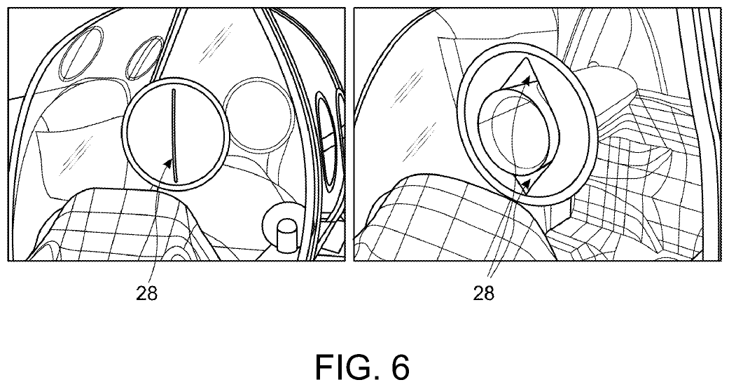

The transparent sheets 14 also comprise openings 22 as shown in FIGS. 5 and FIG. 6. The openings 22 are for insertion of arms or equipment in to the chamber 18 for carrying out procedures on the patient in the chamber 18.

The rigidity of the dome structure 12 also resists excessive movement of the covering 10 when arms or equipment are inserted into and/or extracted from the openings 22. Thus, the semi-rigid sheets 14 prevents aerosol within the chamber 18 from being ‘pumped’ back at a medical practitioner through the openings 22 by movement of the covering 12.

In the example shown in the figures, the transparent sheets 14 have a thickness of between 0.2 mm to 3.0 mm. The transparent sheets 14 are formed from Polyethylene terephthalate glycol-modified (PETG). It will be understood that other suitable materials are intended. These may include PET, PETG, PVC, Solvay's medical-grade Udel® PSU or Radel® PPSU plastic sheets. The structure has a high strength to weight ratio making it light enough for a single person to lift it and manoeuvre it to allow multiples uses, or fast removal form the patient's body part in an emergency. In one embodiment, the total mass of the assembled hood is less than 2 kg. It will be appreciated that the transparent sheets can be made of any material that provides the above discussed properties of being transparent and, when curved, can support the curvature off connected sheets as well as render the covering sufficiently rigid to withstand an amount of deformation during manipulation that would cause air trapped under the cover 10 to be expelled to an outside of the covering 10. The resistance against deformation a curved sheet can provide depends on both its thickness and its Young's modulus. Preferably, the sheet has a flexural modulus, a measure of the stiffness/resistance to bending when a force is applied perpendicular to the long edge of a sample, of between 400 MPa and 7500 MPa. For example, a flexural modulus (Ef) in this range can be achieved by using a sheet having a thickness (h) of approximately 0.2 mm to 3.0 mm and a Young's Modulus (E) of approximately 2000 N/mm² and 2500 N/mm² using the following equation for a 3-point bending test:

$${E}_{f} = \frac{{L}^{3} F}{4 w {h}^{3} d}$$

where w and h are the width and thickness of the beam, L is the distance between the two outer supports of the 3-point bending test, and d is the deflection due to the load F applied at the middle of the beam. d is calculated using the Young's Modulus of the material and the following equation:

$$d = \frac{{L}^{3} F}{48 IE}$$

and l, the second moment of area of the beam's cross-section, is calculated using the following equation for a rectangular beam:

$$I = \frac{1}{12} w {h}^{3}$$

Thus, any combination of material and thickness which exhibits a flexural modulus in this range is suitable.

One or more or all of the lower edges of the dome 12 is arcuate and sized to allow part of the patient's anatomy to protrude to an outside of the dome 12, as shown in FIG. 3 and FIG. 4. The arcuate edges are sized such that the patient's anatomy can comfortably pass under the edge of the dome 12 without pressure from the weight of the dome 12 or from forces applied to the dome 12 when a procedure is performed on the patient being applied to the patient's skin by the edge of the dome 12.

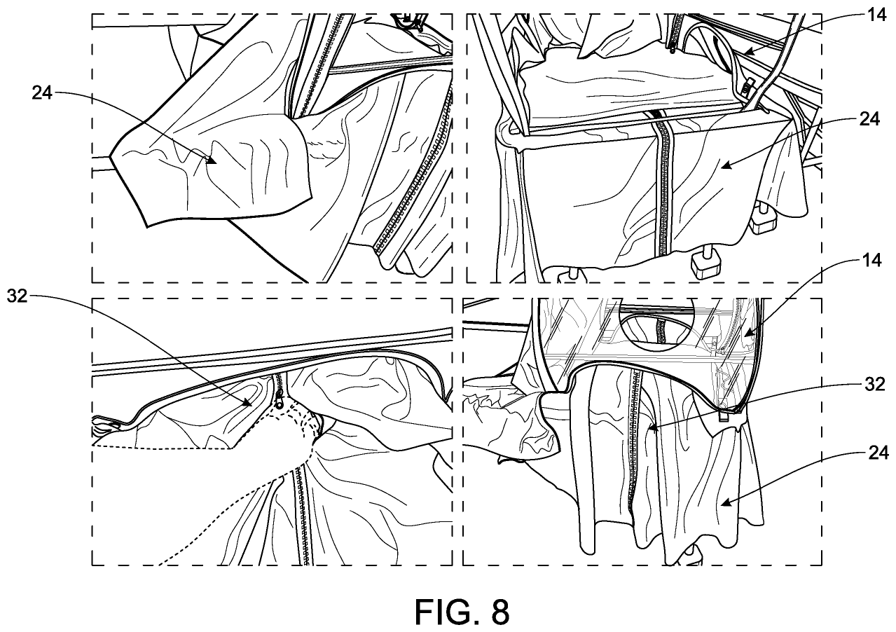

One or more or all of the lower edges of the dome 12 is connected to a pliable skirt 24 as shown in FIG. 3 and FIG. 8. The pliable skirt 24 is made of a material that, in use, is not capable of supporting wide arcuate structures that could form a channel for gas flow out of the dome 12. The skirt 24 is thus made of a material that, when smoothed over a surface, be that part of the patient's body or part of a bed or operating table the patient rests on, the pliable skirt 24 substantially follows the surface closely. The total weight of the pliable skirt is less than 85 g. In an embodiment, the pliable skirt 24 is less than 0.3 mm thick. As can be seen from the figures, the pliable skirt 24 can be provided as a way of sealing along the above-discussed arcuate edges. Additionally the pliable skirt may be provided along straight edges of the dome 12 to provide a means/skirt that can be tucked under a mattress on which the patient lies to prevent egress of gas from the dome 12. The pliable skirt 24 is non-porous to prevent the escape of any contaminated liquids from within the chamber 18 and to be airtight to prevent excessive airflow into the chamber 18. The pliable skirt 24 is formed from one or a combination of polyester, nylon and paper. In an embodiment, the pliable skirt is formed from DuPont Tyvek™ paper based material.

In use, the pliable skirt 24 drapes over a patient's body part and/or the sides of the mattress. The pliable skirt 24 is liquid impermeable so that fluids are not absorbed by it. In an embodiment, the skirt 24 is a woven polymer, for example polyester, impregnated with rubber. The skirt 24 conforms to the shape of the patient's anatomy and the patient can assume any desired resting position using the same covering 12 and without need to remove or readjust the covering 12.

FIGS. 4 (a), (b) and (c) illustrate the covering in use in several patient positions. FIG. 2 (a) shows the covering 10 in use where the patient's upper body is inclined upwardly by 30°. FIGS. 4 (b) and (c) show the patient on their front and back respectively. The skirt 24 provides a side opening of flexible size and position, allowing the patient's arm position to be changed to suit the comfort and/or treatment requirements. Tests elevating a patient's body at various angles have shown that the pliable skirt 24 provides the desired sealing at least from an elevation of 0 degrees to 75 degrees.

FIG. 5 shows the opening 22 in a transparent sheet 14. Depending on the requirements, the transparent sheet 14 may have no openings or it may have multiple openings 22. The openings 22 comprise a substantially circular aperture in the sheet 14. The openings 22 have, in some embodiments, opening diameters of between 150 mm and 250 mm. Preferably, the openings 22 have a diameter of 180 mm which allows the average arm size to be inserted through the opening. It will be appreciated that, whilst the figures show circular openings 22, the openings may for example, be oval, square, rectangular or any other polygonal shape. The length of the widest dimension of the opening 22 is between 150 mm to 250 mm, preferably 180 mm.

The aperture of the opening 22 is enclosed with a flexible material 26 having an elongate slit 28. The presence of the flexible material and the elongate slit 28 allows a person to insert their arm into the inside of the dome 12 through the slit 28 whilst minimising the amount of airflow between the inside and outside of dome 12 through the opening 22. As shown in FIG. 6, the flexible material 26 maintains contact with an arm inserted through the opening 22, as shown in FIG. 6 (b) so that residual airflow through the opening 22 is limited to the areas 21 adjacent either end of the slit 28. The total open flow area for each opening 22 in the transparent sheets 14 of the dome 12 is 10 cm² in the configuration shown in FIG. 5 or FIG. 6 (a), with no arm or medical device is inserted through the elongate slit 28. FIG. 6 (b) shows the configuration of the openings 22 when an arm is inserted into the slit 28, creating open areas 21 between flexible material 26 and the inserted arm. The open area 21 on either side of the arm has a maximum area of 25 cm². The increase in open area is minimised by flexible material 26.

Flexible material 26 allows for arms of varying sizes to be inserted without the need to increase the size open areas 21 provided in the transparent sheet 14. In an embodiment, the flexible material 26 comprises a low friction surface, which prevents snagging of the protective clothing on the arm on the covering 10. The openings ensure a relatively open access allowing free one handed and blind (no requirement to look) passage with or without holding equipment. The flexible material 26 is made from silicon rubber of thickness 0.5 mm to 1.5 mm. Mechanical property of the material is shore hardness between 40 and 60, elongation at break >200 % and tear resistance >15 kN/mm. Silicon rubber exhibits excellent resistance to chemical decontamination fluids.

As illustrated in FIG. 3 the covering 10 of an embodiment comprises up to four faces. There are two arm openings 22 on one of the faces of the dome 12. In use, the face having two arm openings 22 is positioned at the head and of the patient where a medical practitioner can insert his or her arms for carrying out a procedure. The opposite face and the side faces provide side access to the patient's body part whereby a second medical practitioner can insert one arm in the side face and one arm at the base of the head and third medical practitioner can do the same on the opposite side of the head, if required.

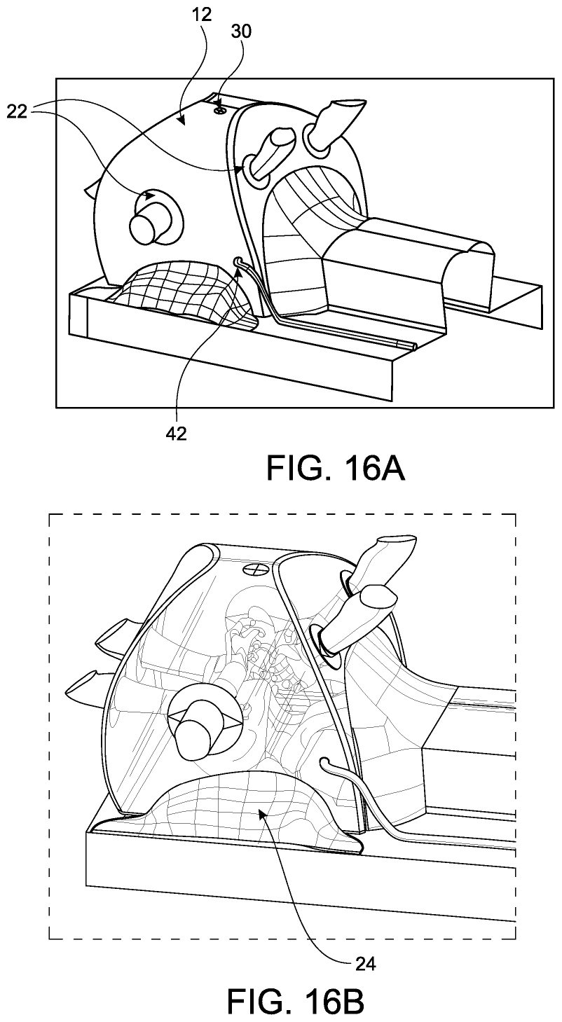

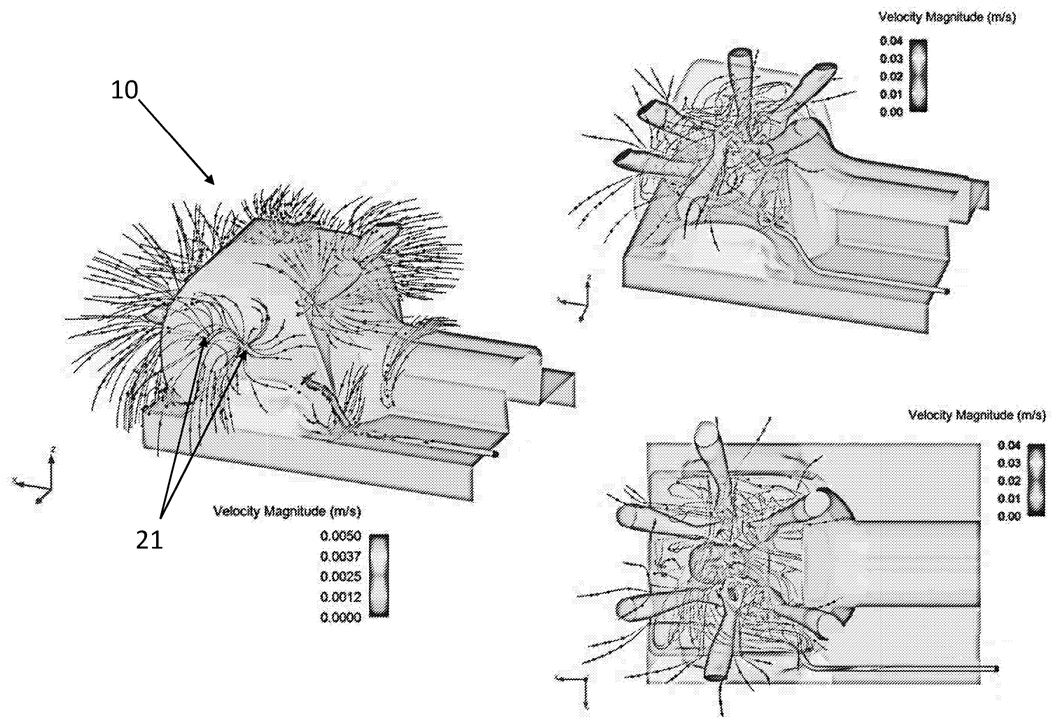

The configuration shown in the figures provides six arm openings 22. Therefore, it allows up to three medical practitioners to perform procedures on a patient in the chamber 18. As shown in FIG. 16 (b) and FIG. 17 several medical practitioners can be positioned around the covering. This is particularly suitable for intubation and extubation procedures where an anaesthetist works at arm's length from the top of the patients head peering down into the chamber through the dome 12 while assistants may approach the patient using the side and foot end aperture. Other procedures for which the covering 12 is beneficial include on ward care in prone and supine positions, tracheostomy clean/tube change, nursing daily care procedures, percutaneous tracheostomies, orthodontic procedures, post Covid-19 recovery clinics, pulmonary procedures, electrosurgical cutting procedures that generate carcinogenic gases, nasendoscopy procedures. As discussed below, the covering 12 can be deployed in conjunction with extraction system 36, 38, 40 enabling clinicians to provide non-invasive ventilator procedures like CPAP, THRIVE or Opti-Flow which otherwise would present higher risk of the spread of Covid-19 virus to the clinicians.

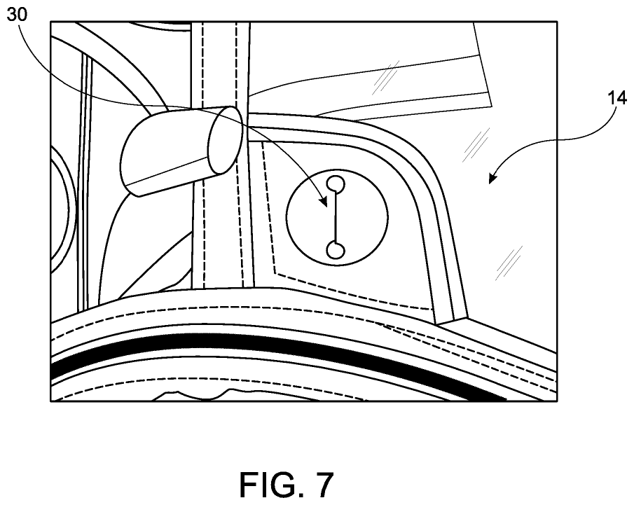

FIG. 7 shows an opening 30 proximate to the apex of the covering 10. Opening 30 is suitable for insertion of tubing required for treatment. For example, opening 30 allows passage of ventilation system and pipes into the chamber 18. The opening 30 comprises a substantially circular aperture in the semi-rigid transparent sheet 14 and a flexible material enclosing an elongate perforation. As with the arm openings 22, the flexible material of opening 30 deforms around the contours of the inserted tubing to minimise the additional opening, and hence additional airflow possible, created between the inside and the outside of the chamber 18.

FIG. 8 shows the dome 12 positioned on a surface wherein skirt 24 is draped outwards from the base of the dome 12. In use, the skirt 24 is suitable for tucking under a mattress or the sides of the patient to reduce the openings between the inside and outside of the chamber 18. As shown in FIG. 8 portions of the skirt 24 comprise a double zip 32 (i.e. a zip with two sliders that allow the opening of the zip 32 between the two sliders without needing to open the zip all the way to an end of it) extending from the base of the dome. The double zip 32 provides quick access for pipes and equipment into the chamber 18.

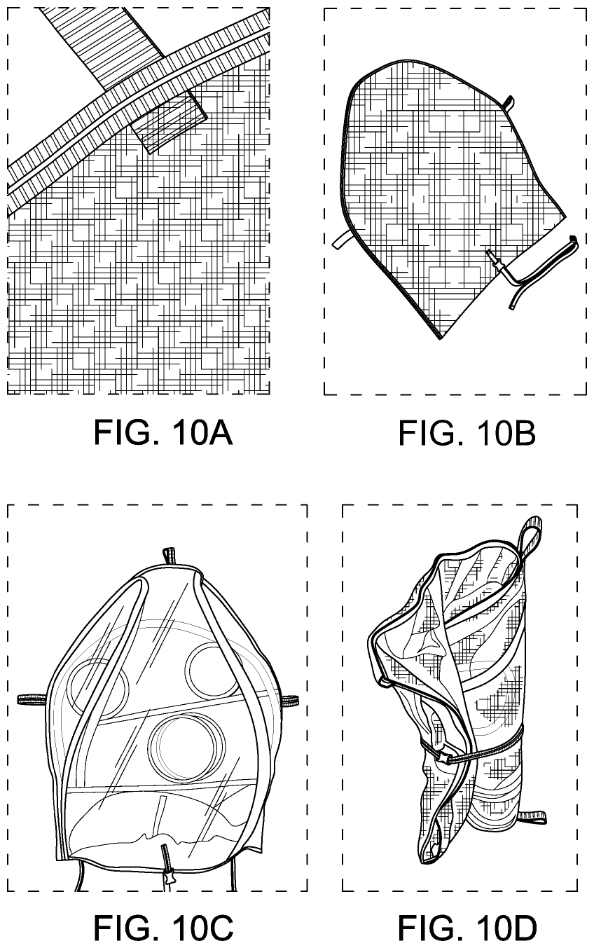

FIG. 10 illustrates an arrangement for use in cleaning the covering 10 so that it can be reused. When the cover 10 is disassembled, i.e. when the sheets 14 are not connected to each other along their edges, the semi-rigid nature of the sheets making up the cover allows the sheets to be rolled into a tubular shape, which can be submerged in decontamination fluids. The covering 10 comprises materials that can withstand such decontamination fluids, for example chlorine-based disinfectants. The covering 10 in tube form is initially submerged by dipping it, in a longitudinal direction relative to the tube axis, into the container of decontamination fluid 34. Depending on the size of decontamination container the covering 10 in tube form can be turned 180° to be submerged from the other end of the tube if the decontamination container is not large enough to receive the covering 10 completely without turning. In an embodiment, looped fabric lifting handles are provided at each end for this operation. FIGS. 10 (a)-(d) shows a permeable bag which is used to retain the covering 10 in a rolled up form. The permeable bag comprises a porous weave, shown in FIG. 10 (a) to allow flow of the decontamination fluids around the covering 10. As shown in FIGS. 10 (c) and (d) the permeable bag has two handles to allow the covering 10 to be submerged from two ends to ensure even submersion. The covering 10 is then dried for reuse. Alternatively, the covering may be mass-produced so that cleaning is not required. In this case, the system is disposed of after use by de-construction and placing in an incineration sack.

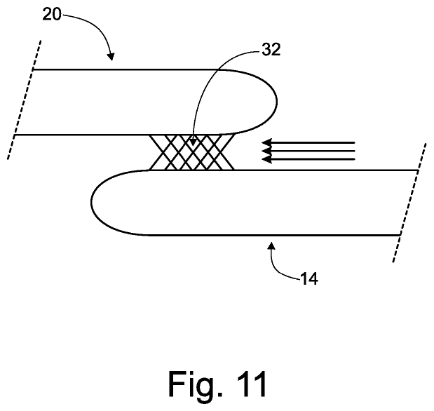

FIG. 11 shows a cross section of the join 32 between the fastener 20 (i.e. a zip for example) and the transparent semi-rigid sheet 14 of the covering 10. The join or seam 32 between the components, and any components of the covering 10 (e.g. the flexible material 26 of the openings 22 ), comprises a permeable spacer 32. The permeable spacer 32 allows ingress of liquid, in particular decontamination fluid, to the space between the semi-rigid sheet 14 and fastener 20. It will be appreciated that, if two pieces of sheet material were in direct contact with each other (i.e. without the presence of the permeable spacer 32), contaminated liquid present within the covering 10 may seep into the space between the two pieces of sheet material through capillary action and be retained in this space, even when the cover 10 is submerged in decontamination fluid. Whilst providing the spacer 32 does not prevent contaminated gases and fluids from entering in the space between the two overlapping sheets, the presence of the spacer 32 prevents retention of any contaminants between the two overlapping sheets through capillary action. Moreover, the presence of the spacer allows easy ingress of decontamination fluids during a decontamination procedure so that the decontamination fluid can reach spaces of the cover 10 that would otherwise be difficult or impossible to access. In so doing, the permeable spacer 32 prevents build-up of pathogens in this space. Thus, the covering 10 can be completely cleaned and is safe to reuse in a medical environment. A major drawback of known covers is the use of wipe down procedures because of the large surface area it is difficult to ensure 100% coverage using a wipe down method. As such, the described covering 10 is suitable for complete cleaning by full submersion into, for example, a chlorine based disinfectant solution. Alternatively, the components are glued together or are integrally formed.

It will be appreciated that, whilst the structure of the join shown in FIG. 11 is described with reference to the join between a semi-rigid sheet 14 and a fastener 20, any join used in the cover 10 can be configured using this structure, including the joins between semi-rigid sheet 14 and flexible material 26 and between semi-rigid sheet 14 and pliable skirts 24. It will equally be appreciated that, in an alternative embodiment, the join is created by providing an adhesive between overlapping areas of material so that gaps that could harbour contaminated fluids are eliminated.

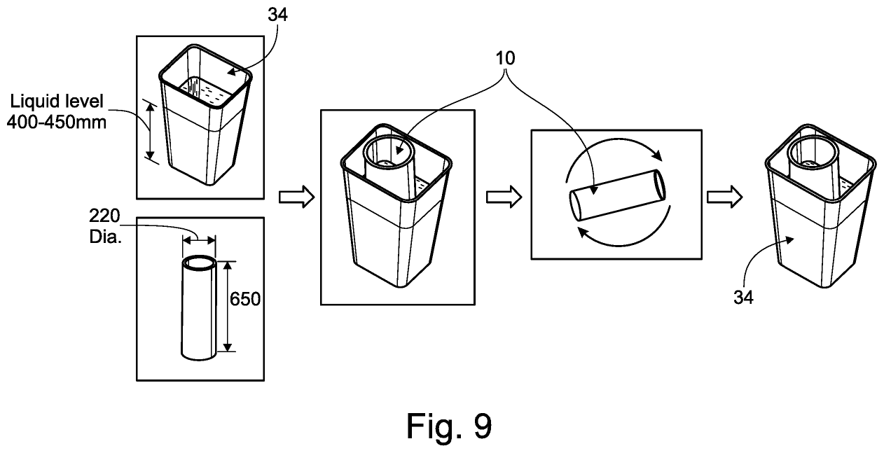

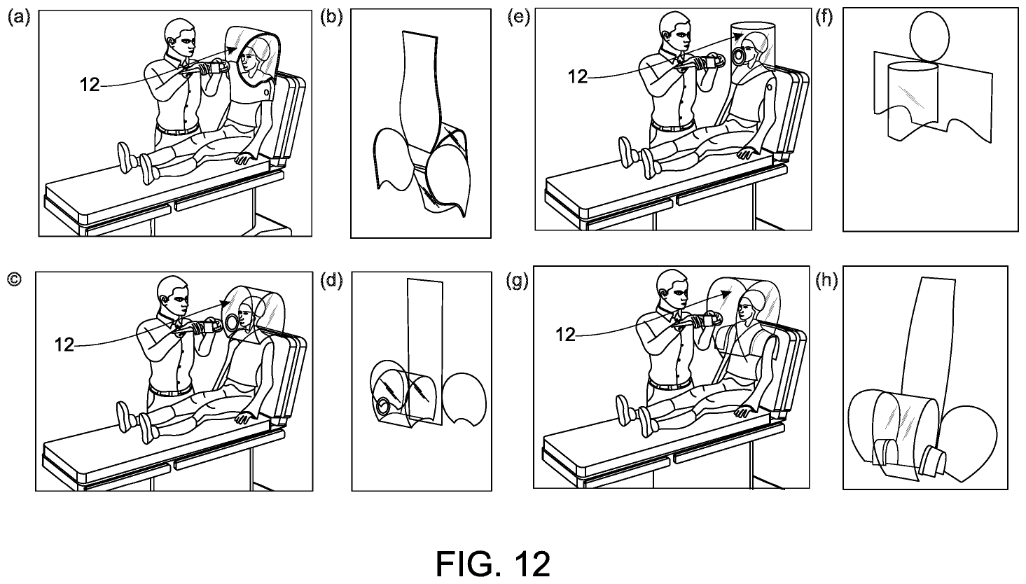

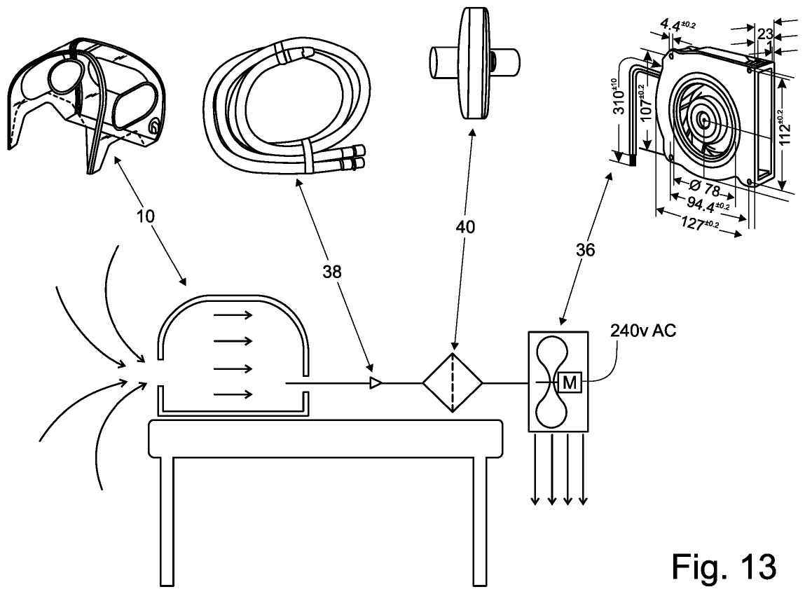

In an embodiment, the cover 10 is as described in relation to any of FIGS. 1-11. However, it will be understood that an alternative cover could be used, not least for different procedures. For example, the embodiments of the cover shown in FIGS. 12 (a)-(h) are particularly useful for observation, diagnosis and post Covid-19 recovery clinics.

It will be understood that the features described above in relation to FIG. 1 to FIG. 11 are also applicable to the covering of FIGS. 12 (a)-(h). As shown, cover 10 comprises a dome 12 formed by a single transparent sheet 14. The single transparent sheet comprises a blank having segments. The sheet 14 can have numerous shapes as shown in shown in FIGS. 12 (b), (d), (f) and h). In the embodiments of FIGS. 12 (a) and (b), FIG. 12 (c) and (d) and the embodiments shown in FIGS. 12 (g) and (h) the blank comprising three segments. In the embodiments of FIGS. 12 (e) and (f) the blank comprising only two segments The blanks comprise fold lines, for example a thinner portion of material, around which the foldable segments can be adjusted to form the self-supporting structures shown in FIGS. 12 (a), (c), (e) and (g). The free edges of the sheet segments are fastenable to each other via means already discussed.

Whilst coverings made of two, three and four segments are discussed in detail herein it will be appreciated that coverings made from a larger number of segments are also encompassed by the present disclosure. It will moreover be understood that, whilst FIGS. 12(a ) to 12(h ) show embodiments in which the segments forming the covering are connected to each other so that they are assemblable from a single piece of semi-rigid sheet material, the individual segments could equally be separate from each other when delivered and then connected to each other during assembly to form the shape of the covering.

As discussed the cover 10 has openings 22, 30 for the insertion of tubing and/or arms for treatment of the patient. The openings are as shown in FIG. 6 and FIG. 7 and described in detail above. In this embodiment, the lower edges of the covering 10 are suitable for placing on a patient's shoulders, whereby the dome remains self-supporting and upright on the shoulders and covering the patients head to prevent spread of aerosols from the patient to the clinician.

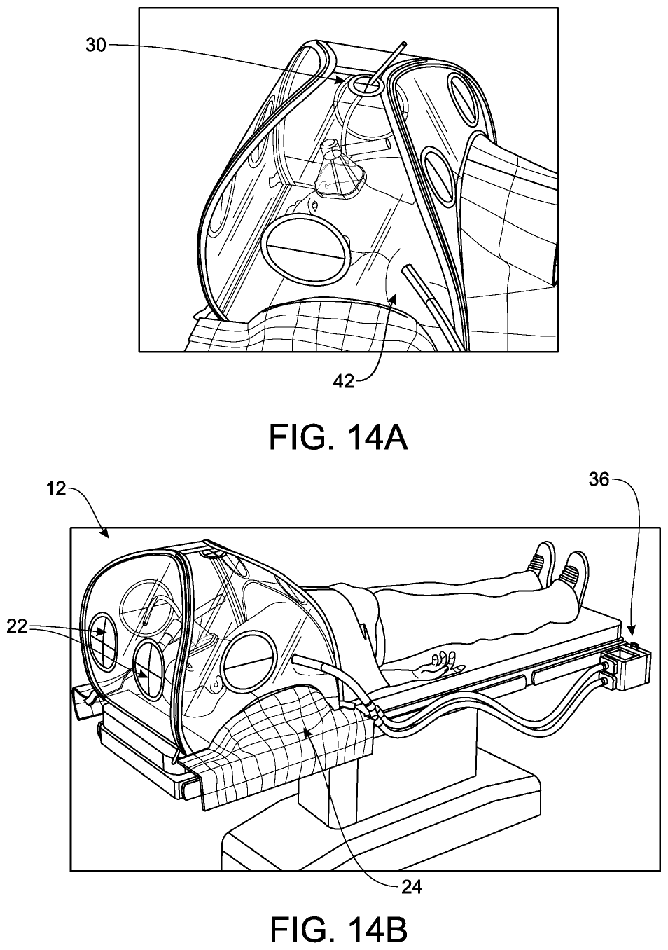

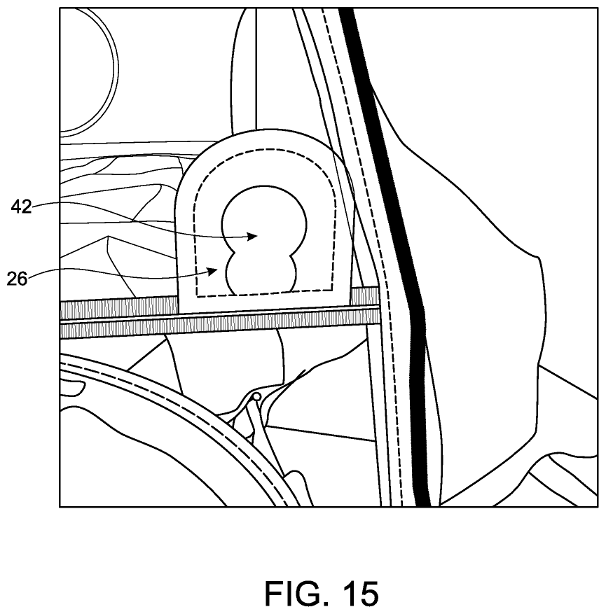

FIG. 13 shows a safety assembly according to an aspect of the present disclosure. The safety apparatus comprises a cover 10 connected to an extracting means 36. The cover 10 is as described in relation to any of FIGS. 1-12. However, it will be understood that an alternative cover could be used, not least for different procedures. The extracting means 36 is a fan 36 suitable for continuously extracting fluids. As shown in FIGS. 14 (a) and (b) the assembly further comprises tubing 38, which attaches to the cover 10 via one or two openings 42. In a preferred embodiment, extraction from two sides of the cover 10 is used to provide better air circulation over the patient. This helps prevent build-up of condensate within the cover 10 and provides evenly distributed cooling airflow passing over the patient. The use of two extraction points moreover prevents a situation where an inadvertent occlusion of one extraction point prevents extraction of air from the covering 10. One of the extraction openings 42 is shown in FIG. 15. The openings 42 is positioned proximate to the base of the dome 12 such that in use they are proximate a patient's shoulders. The openings 42 comprise an inlet surrounded by flexible material 26 as described in relation to the arm openings 22 and tube opening 30. The join 32 between the transparent semi-rigid sheets and the flexible material 26 of the opening 42 is as described above in one embodiment.

A filter 40 is positioned between the covering 10 and the extraction means 36. The extraction means 36 is in fluid communication with the inside of the covering 10 via the tube 38 and filter 40 so that it extracts gas, i.e. aerosol, from the chamber 12 and pulls it through the filter 40 before expelling the gas into the surrounding environment. It is found that standard, low cost clinical filters, for examples those rated at HEPA H14 used in the clinical routine are suitable for decontaminating gas extracted continuously from the covering 10 using a flow rate of >400 L/min.

The extraction means 36 comprises a low level and unobtrusive air extraction system with specific airflow rate to overcome aerosol escape during procedures with up to three clinicians simultaneously. The filter 38 and extraction means 40 comprise standard tubes 38 and filter cartridges 40. The tubes 38 and filter cartridges 40 are disposable after use.

FIGS. 16 (a) and (b) illustrates a numerical model used in simulating the extraction of aerosol from the chamber 18 during a procedure requiring six arms inside the chamber 18. FIG. 17 shows results of the numerical simulation, illustrating the airflow path surrounding the openings 22, 30, 42 in the covering 10 when the extraction means 36 is in use. The simulation is 3D, Steady State, Detached Eddy Simulation (DES) run using the Spalart-Allmaras Viscous Model, in ANSYS Fluent software. FIG. 17 shows the effectiveness of the extraction at reducing escape of aerosol through the openings when the extraction fan continuously extracts fluid from the chamber at 400 L/min. FIGS. 16 (a) and (b) display the gaps around the covering that potentially allow fluid communication between the inside of the chamber and the outside of the chamber. The blue lines indicate that, when arms are inserted into the chamber creating gaps 21, air is sucked into the chamber 18 through the gaps 21 by the extraction means 36, rather than escaping. Therefore, the medical practitioners are protected from any aerosols emanating from the patient within the chamber 18.

While certain embodiments have been described, these embodiments have been presented by way of example only, and are not intended to limit the scope of the inventions. The size of the dome 12 is adaptable to fit different bed sizes and designs. The dome 12 can be affixed to a bed/mattress for example when the patient is inclined toward a siting up position FIG. 4 (a) or for patients in transit FIG. 4 (b) using fixation straps. Furthermore the dome 12 will generally fit patients of all sizes for example including range of body sizes, e.g. 1.57 m, 44.4 Kg-1.85 m, 101 Kg, and can also be scaled up or down depending on the procedure.

1. A covering for a body part of a patient, comprising;
a plurality of transparent semi-rigid sheet segments,
a fastener for connecting the plurality of transparent semi-rigid sheet segments together such that the sheet segments support each other to form a self-supporting structure suitable for covering the body part of a patient.

2. A covering according to claim 1, wherein the plurality of transparent semi-rigid sheet segments comprise a plurality of openings for insertion of arms into an inside of the covering,
wherein the rigidity of the structure is sufficient for a dome structure to, when an arm is inserted into a chamber through an opening, resist movement thereby minimising or preventing expulsion of a gas within the covering to an outside.

3. The covering of claim 1, wherein the plurality of transparent semi-rigid sheet segments comprise a material having a Flexural modulus of between 400 MPa and 7500 MPa.

4. The covering of claim 1 wherein the transparent semi-rigid sheet segments have a thickness of between 0.2 mm and 3.0 mm.

5. The covering of claim 2 wherein the opening has a widest dimension of between 150 mm and 250 mm.

6. The covering of any preceding claim 2, wherein total open area of each opening in a first state is 10 cm², wherein in the first state no arm is inserted into the chamber and wherein the total open area is the area which provides fluid communication between inside and outside of the chamber.

7. The covering of any preceding claim 2, wherein total open area of an opening in a second state is a maximum of 25 cm², wherein in the second state all openings have arms inserted into the chamber and wherein the total open area is the area which provides fluid communication between inside and outside of the chamber.

8. The covering of claim 2, wherein at least one of the openings is covered by a flexible seal, the flexible seal comprising an elastically deformable seal opening configured to admit a human arm through the seal opening.

9. The covering of claim 8, wherein the flexible seal and the seal opening is configured to deform around an inserted arm to create a maximum total opening area around the arm through the seal opening for fluid communication between inside and outside of the chamber of less than or equal to 25 cm².

10. The covering of claim 1, wherein at least one of the transparent semi-rigid sheet segments comprises a bougie opening which near an apex of the cover.

11. The covering of claim 2, wherein at least one of the transparent semi-rigid sheet segments further comprises a reinforcing means for increasing stiffness of the dome in a direction orthogonal to an axis.

12. The covering of claim 1 wherein the transparent semi-rigid sheet segments, when not fastened to each other, are rollable into a tubular shape.

13. The covering of claim 1, wherein at least one of the transparent semi-rigid sheet segments comprises an arched edge for permitting a patient's body part to extend between an inside and an outside of the covering.

14. A covering for a body part of a patient, comprising;
a structure for covering a patient's body part comprising a plurality of semi-rigid sheet segments and connected to each other along joins and forming a chamber between the structure and a surface upon which the structure rests and/or the patient, the covering comprising a plurality of openings for insertion of arms into the chamber;
wherein a part of the covering comprising said plurality of openings curves convexly outwardly so as to provide an unobstructed view into the chamber.

15. The covering of claim 14, wherein the plurality of semi-rigid sheet segments comprise complimentary shapes configured to provide a self-supporting dome shape, with seams connecting the sheets positioned such that they are out of line of sight of a human of average height manipulating a patient, wherein the patient is positioned horizontally at a height between 60 and 100 cm above ground.

16. A covering for a body part of a patient, comprising;
a substantially dome shaped structure for covering a patient's body part and forming a chamber between the dome and a surface and/or patient, the structure comprising edges that are, in use, to be placed adjacent part of a patient's anatomy or a surface upon which a patient rests;
wherein at least one of the edges comprises a pliable skirt for providing continuous contact between a base of the dome and a surface and/or a body part of a patient.

17. The covering of claim 16 wherein the skirt comprises accessible portions which are openable and closable to allow insertion of items into the chamber.

18. A covering for a body part of a patient, comprising;
a substantially dome shaped structure for covering a patient's body part and forming a chamber between the dome and a surface and/or patient,
the covering comprises a plurality of overlapping components,
wherein overlapping components are connected using a spacer or spacers that allow for ingress of liquid between a plurality of sheets.

19. The covering of claim 18, further comprising a pliable skirt arranged along at least one edge of the covering, the skirt overlapping a sheet material forming the edge and connected to the sheet material using a spacer or spacers that allow ingress of liquid between the sheet material.

20. The covering of claim 18, wherein the spacer or spacers comprise a woven fluid permeable material.

21. A set of semi-rigid sheets and fasteners, assemblable into a covering according to claim 1, by connecting the sheets using the fasteners.

22. A safety apparatus comprising;
a substantially dome shaped covering for covering a patient's body part suitable for forming a chamber between the dome and a surface and/or patient, the covering comprising a plurality of openings for insertion of arms into the chamber;
an extraction means connectable to the chamber and suitable for continuously extracting gas from the chamber at a rate that creates an inflow of gas through the openings towards the extraction means, thereby preventing gas escaping from the chamber through the openings.

23. The safety apparatus of claim 22, wherein the extraction means is in fluid communication with the chamber at two positions.

24. The safety apparatus of claim 22, wherein the extraction means comprises a tube having a first end and a second end, wherein the tube is in fluid communication with the chamber at the first end and connected to a pump at the second end.

25. The safety apparatus of claim 24, wherein the extraction means further comprises a gas filter positioned between the chamber and the pump, for filtering the gas extracted from the chamber.

26. The safety apparatus of claim 22, wherein the extraction means is configured to extract gas from the chamber at a rate of at least 400 L/min.
